(19) United States
(12) Patent Application Publication
(10) Pub. No.: US 2013/0232337 A1
(43) Pub. Date: Sep. 5, 2013

(54) USER TERMINAL AND METHOD FOR PLAYING DIGITAL RIGHTS MANAGEMENT CONTENT

(71) Applicant: Electronics and Telecommunications Research Institute, (US)

(72) Inventors: Seung-Min LEE, Daejeon (KR); Hyeok-Chan KWON, Daejeon (KR); DONG-IL SEO, Daejeon (KR); Sok-Joon LEE, Daejeon (KR); Yong-Hyuk MOON, Daejeon (KR)

(73) Assignee: Electronics and Telecommunications Research Institute, Daejeon (KR)

(21) Appl. No.: 13/779,657

(22) Filed: Feb. 27, 2013

(30) Foreign Application Priority Data
Mar. 2, 2012 (KR) 10-2012-0021791

(51) Int. Cl. H04L 9/32

(52) U.S. Cl. CPC H04L 9/3263
USPC 713/156

(57) ABSTRACT

Disclosed herein are a user terminal and method for playing DRM content. The user terminal includes a common security platform. The common security platform includes a DRM application management unit and a security management unit. The DRM application management unit stores and executes a DRM application that requests authentication from a license server and receives a license, including a decryption key for decrypting encrypted DRM content. The DRM application is an application in a downloadable form. The security management unit decrypts the encrypted DRM content, provided by a content providing server, using the decryption key included in the license issued via the DRM application.

### CROSS REFERENCE TO RELATED APPLICATION

This application claims the benefit of Korean Patent Application No. 10-2012-0021791, filed on Mar. 2, 2012, which is hereby incorporated by reference in its entirety into this application.

### BACKGROUND OF THE INVENTION

1. Technical Field

The present invention relates generally to a user terminal and method for playing Digital Rights Management (DRM)-protected content and, more particularly, to a user terminal and method for playing DRM-protected content, in which a common security platform for performing a core security function that belongs to the functions of the DRM agents of the user terminal and that is required in common by various DRM techniques is previously installed during the process of fabricating the user terminal and in which an application for performing the remaining functions that are required by a specific DRM technique and that are different from the core security function is downloaded and installed in the user terminal, so that various DRM methods can be supported in an extensible manner.

2. Description of the Related Art

Methods of protecting digital content include several protection methods of applying encryption to content so that only a person having rights to view the content can play the content Representative among such methods is the technology of DRM. In DRM technology, even if content is illegitimately downloaded, only a user who has obtained rights to play the content via a legitimate channel can play and view the content because the content was encrypted.

A common process by which a user plays content to which DRM has been applied will now be described. A user is provided with DRM-protected content (hereinafter referred to as “DRM content”) by a content server during the purchasing process, and is supplied with a license required to play the content by the license server. The owner of the copyright for the content may set a Rights Object (RO) for the use of the content via the license, and prevent illegitimate distribution.

DRM content is an encrypted version of original content, and can be used on a user terminal that has paid the appropriate fees. For this purpose, the DRM agent of the user terminal receives a license, including a decryption key capable of decrypting encrypted DRM content and RO information (e.g., information about the number of playbacks and the period of use) from a license server. In order to enhance security in the user terminal, a certificate for authenticating the user terminal is inserted into the user terminal when the user terminal is fabricated, and the DRM agent is also subordinated to and installed onto a platform when the user terminal is fabricated.

Standards for DRM technology include standards established by international standardization organizations, such as MPEG-21, OMA, and DMP. However, interoperability between DRM techniques is not guaranteed even for the same DRM standard because the DRM techniques are implemented using different methods that are adopted by terminal manufacturers. For example, since Microsoft Corp. uses a DRM technology called Play Ready and Apple Inc. uses a DRM technology called Fair Play, the DRM content of a terminal fabricated by Microsoft Corp. and the DRM content of a terminal fabricated by Apple Inc. are not interoperable even when the pieces of DRM content correspond to the same content. For this reason, problems arise in that a content producer should produce a number of DRM content equal to the number of types of DRM techniques used to provide the service and a user cannot play purchased DRM content on other types of terminals.

Meanwhile, representative standards and techniques that were proposed to overcome the problem of interoperability between DRM techniques include EXIM and CORAL. EXIM started being developed by the Electronics and Telecommunications Research Institute (ETRI) in 2004 in order to provide an open technology standard for supporting interoperability between different DRM systems, and was then commercialized by Enka Entworks Inc. EXIM functions as a mediator for converting pieces of DRM content having different standards into a neutral EXIM format. However, EXIM is problematic in that each service provider should develop and install a technology that performs the conversion into the mediator and EXIM has many limitations imposed on its use because EXIM is a very complicated technology having an N-to-N relationship to support the neutral format

CORAL is a standardization organization for DRM interoperation, and proposed a framework in which base system elements for DRM interoperability are defined. However, there are few cases in which the framework of CORAL and an echo system based on conversion between various pieces of DRM content have been implemented because it is practically very complicated and difficult to apply the standard model proposed by CORAL.

### SUMMARY OF THE INVENTION

Accordingly, the present invention has been made keeping in mind the above problems occurring in the prior art, and an object of the present invention is to provide technology for playing DRM content, which is capable of solving the problem of conventional DRM technology for protecting content which may maintain high security by installing a DRM agent in the platform of a user terminal during a process of fabricating the terminal, but does not provide interoperability because it does not recognize content protected by DRM technology having a standard different from the conventional DRM technology applied to the DRM agent installed in the platform.

In order to accomplish the above object, the present invention provides a user terminal for playing DRM content, including a common security platform, the common security platform including a DRM application management unit for storing and executing a DRM application configured to request authentication from a license server and to receive a license, including a decryption key for decrypting encrypted DRM content, wherein the DRM application is an application in a downloadable form; and a security management unit for decrypting the encrypted DRM content, provided by a content providing server, using the decryption key included in the license issued via the DRM application.

The security management unit may include a certificate management unit for providing a certificate for the user terminal, used to play the DRM content, to the DRM application; and the DRM application comprises an authentication request module for requesting the license server to authenticate the user terminal by transferring the certificate for the user terminal to the license server.

The DRM application may further include a license management module for requesting the license from the license server and receiving the license issued by the license server.

The decryption key may be encrypted by the license server and included in the license; and the DRM application may further include a key extraction module for extracting the encrypted decryption key included in the license.

The security management unit may further include a decryption key generation unit for generating the decryption key from the encrypted decryption key extracted by the key extraction module of the DRM application, using a secret key.

The security management unit may further include a storage unit for storing the secret key and the certificate for the user terminal.

The license may further include RO information for the DRM content; and the DRM application may include an RO check module for checking whether the user terminal has rights to play the DRM content based on the RO information included in the license.

The DRM application may further include a decryption request module for requesting the security management unit to decrypt the encrypted DRM content if the RO check module determines that the user terminal has rights to play the DRM content

The security management unit may include a content decryption unit for decrypting the encrypted DRM content in response to a request from the decryption request module of the DRM application.

The security management unit may include an application verification unit for verifying the integrity of the DRM application.

The DRM application may include a content verification module for verifying integrity of the encrypted DRM content

In order to accomplish the above object, the present invention provides a method of playing DRM content, including, by a DRM application management unit, downloading and storing a DRM application for requesting a license server to authenticate a user terminal for playing DRM content and for receiving a license, including a decryption key for decrypting encrypted DRM content; by the DRM application management unit, executing the downloaded DRM application, requesting the authentication of the user terminal from the license server, and receiving results of the authentication; by the DRM application management unit, requesting the license from the license server via the DRM application, and receiving the license from the license server; by the DRM application management unit, extracting the decryption key from the license using the DRM application; by a security management unit, decrypting the encrypted DRM content using the decryption key; and by a content play platform, playing DRM content decrypted by the security management unit

The decrypting the encrypted DRM content using the decryption key may include generating the decryption key from an encrypted decryption key using a secret key if the decryption key was encrypted by the license server.

The method may further include, by the DRM application management unit, determining whether the user terminal has rights to play the DRM content based on Rights Object (RO) information included in the license by using the DRM application.

The method may further include, by the security management unit, verifying integrity of the DRM application stored in the DRM application management unit.

The method may further include, by the DRM application management unit, verifying integrity of the encrypted DRM content by using the DRM application.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a DRM system to which a user terminal for playing DRM content according to the present invention has been applied;

FIG. 2 is a diagram schematically showing the configuration of the user terminal for playing DRM content according to the present invention;

FIG. 3 is a diagram showing the configuration of a DRM application installed in the DRM application management unit of the user terminal shown in FIG. 2, according to the present invention;

FIG. 4 is a diagram showing the configuration of a security management unit of the user terminal shown in FIG. 2, according to the present invention; and

FIG. 5 and FIG. 6 are flowcharts illustrating a method of playing DRM content according to the present invention.

### DESCRIPTION OF THE PREFERRED EMBODIMENTS

A user terminal and method for playing DRM content according to embodiments of the present invention will be described in detail below with reference to the accompanying drawings. In the following description, the terms and words that are used in the specification and claims should not be interpreted as being limited to their general or dictionary meanings. The embodiments described in the specification and the configuration illustrated in the drawings are merely examples of the present invention and do not exhaustively cover the overall technical spirit and scope of the present invention. Therefore, it should be appreciated that there may be a variety of variations, modifications and equivalents which can replace the examples at the time at which the present application is filed.

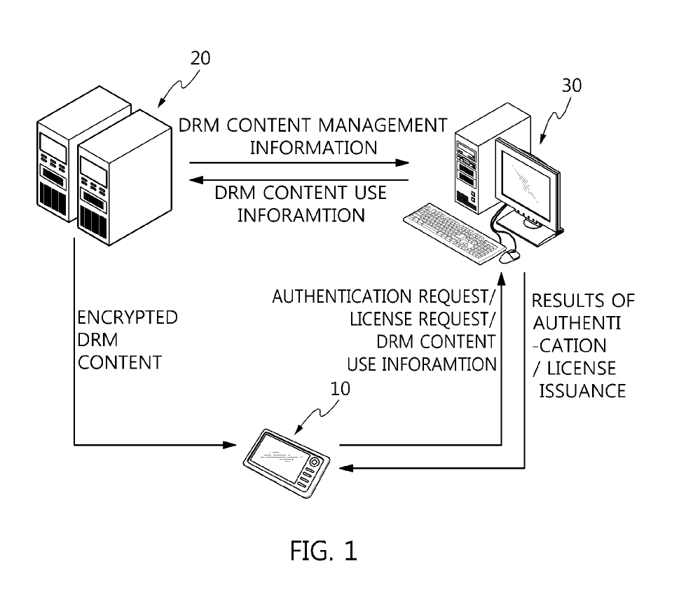

The configuration and operation of a user terminal 10 for playing DRM content according to the present invention will now be described below with reference to FIGS. 1 to 4.

FIG. 1 is a diagram illustrating a DRM system to which the user terminal 10 for playing DRM content according to the present invention has been applied.

Referring to FIG. 1, the user terminal 10 for playing DRM content according to the present invention is connected to a content server 20 for generating and managing encrypted DRM content in order to provide a user with a content service using DRM technology, and a license server 30 for authenticating the user terminal 10 and then issuing a license so that the user terminal 10 can play DRM content provided by the content server 20 via a wireless communication connection. The user terminal 10 for playing DRM content also operates in conjunction with the content server 20 and the license server 30.

More particularly, the content server 20 packages original content in a DRM format, registers and manages the DRM content, and provides the DRM content to the user terminal 10. Furthermore, the content server 20 shares with the license server 30 information about the management of DRM content provided to the user terminal 10 and information about DRM content used by the user terminal 10.

The license server 30 performs the functions of registering and managing the user terminal 10. Furthermore, the license server 30 authenticates the user terminal 10, and issues a license, that is, RO information that specifies the details of the purchase of the DRM content of a user and usage rules, to the user terminal 10.

The user terminal 10 stores and manages the certificate and key thereof, and requests the license server 30 to authenticate the user terminal 10 and issue a license to the user terminal 10. As will be described later, in the user terminal 10 according to the present invention, a core security function required in common by various DRM agents is separated and implemented as a common security platform when the user terminal 10 is fabricated, and functions other than the core security function are implemented in the form of an application which may be downloaded using an DRM method. Accordingly, the common security platform of the user terminal 10 functions as one independent DRM agent while operating in conjunction with a specific application.

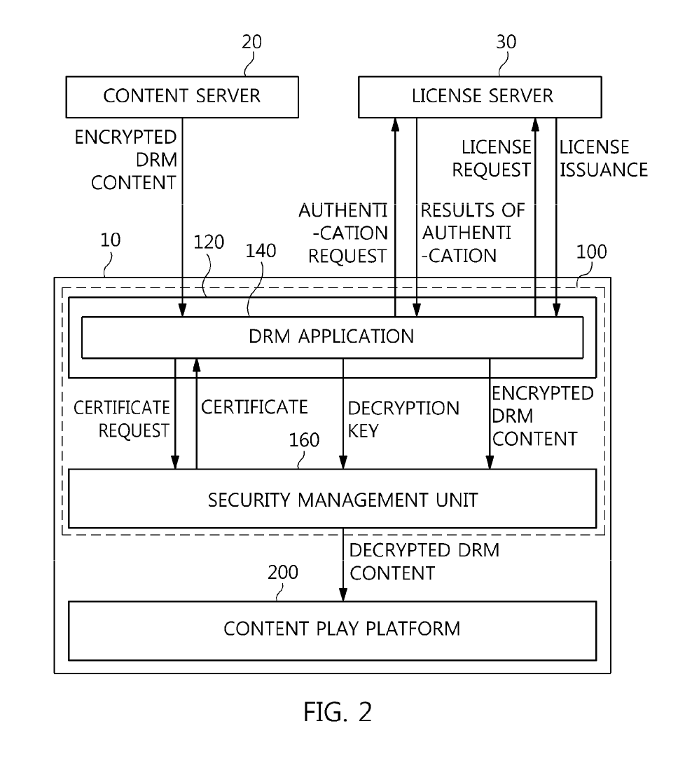

FIG. 2 is a diagram schematically showing the configuration of the user terminal 10 for playing DRM content according to the present invention.

Referring to FIG. 2, the user terminal 10 for playing DRM content according to the present invention includes a common security platform 100 and a content play platform 200 for playing DRM content decrypted by the common security platform 100. The common security platform 100 includes a DRM application management unit 120 configured such that a DRM application 140 fabricated in a downloadable form is installed therein, and a security management unit 160 configured to perform a core security function required in common by various conventional DRM agents.

The DRM application management unit 120 of the common security platform 100 downloads the DRM application 140 from the outside in compliance with a user command, stores the downloaded DRM application 140, and manages and executes the stored DRM application 140. Here, the DRM application 140 installed in the DRM application management unit 120 is an application that corresponds to DRM content that is produced based on a specific one of various DRM techniques. The DRM application 140 analyzes encrypted DRM content provided by the content server 20, and verifies integrity based on the results of the analysis. Furthermore, the DRM application 140 requests a certificate for the user terminal 10 from the security management unit 160, receives the certificate from the security management unit 160, transfers the certificate of the user terminal 10 to the license server 30, requests authentication for the user terminal 10, and receives the results of the authentication from the license server 30. Furthermore, when the user terminal 10 is authenticated by the license server 30, the DRM application 140 requests a license from the license server 30 and then receives the license issued by the license server 30. Here, the license issued by the license server 30 includes RO information for DRM content and a decryption key capable of decrypting the encrypted DRM content provided by the content server 20. Furthermore, the DRM application 140 extracts the decryption key from the license issued by the license server 30, sends the decryption key to the security management unit 160, checks whether the user terminal 10 has rights to play DRM content provided by the content server 20 based on the RO information included in the license, and then sends the encrypted DRM content to the security management unit 160.

The security management unit 160 stores and manages the certificate for the user terminal 10 and sends the certificate for the user terminal 10 to the DRM application 140 in response to the request from the DRM application 140. Furthermore, the security management unit 160 decrypts the encrypted DRM content using the decryption key extracted from the license by the DRM application 140. Once the decryption key extracted from the license by the DRM application 140 has been encrypted by the license server 30, the security management unit 160 generates an encryption key using a secret key stored in and managed by the security management unit 160.

The content play platform 200 receives the decrypted DRM content from the security management unit 160 of the common security platform 100, and plays the received DRM content

Although not shown in FIG. 2, the user terminal 10 according to the present invention may further include a standardized interface configured to send and receive a certificate for the user terminal 10, a decryption key, and DRM content between the DRM application management unit 120 and the security management unit 160.

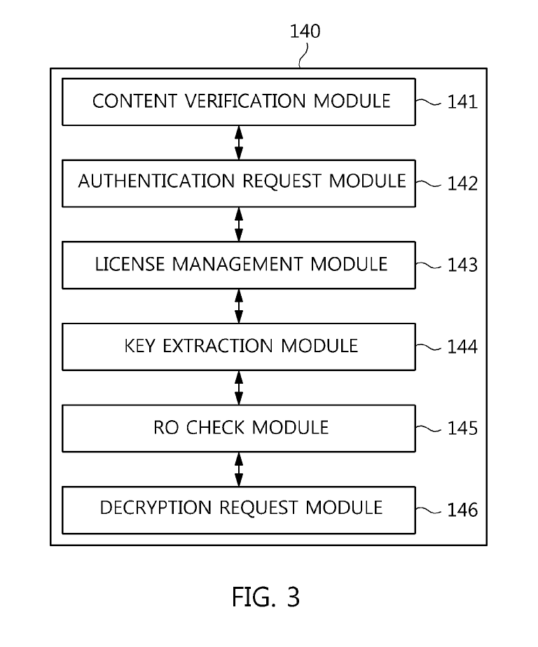

FIG. 3 is a diagram showing the configuration of the DRM application 140 installed in the DRM application management unit 120 of the user terminal 10 shown in FIG. 2, according to the present invention.

Referring to FIG. 3, the DRM application 140 includes a content verification module 141, an authentication request module 142, a license management module 143, a key extraction module 144, an RO check module 145, and a decrypting request module 146.

The content verification module 141 analyzes encrypted DRM content provided by the content server 20, and verifies the integrity of the encrypted DRM content based on the results of the analysis.

The authentication request module 142 requests a certificate for the user terminal 10, used for the license server 30 to authenticate the user terminal 10, from the security management unit 160, and receives the certificate from the security management unit 160. After the certificate for the user terminal 10 has been received from the security management unit 160, the authentication request module 142 transfers the certificate to the license server 30 so that the license server 30 can perform authentication on the user terminal 10, and receives the results of the authentication from the license server 30.

After the authentication of the user terminal 10 has been performed by the authentication request module 142 and the license server 30, the license management module 143 requests a license, including RO information and a decryption key capable of decrypting the encrypted DRM content, from the license server 30, and receives the license issued by the license server 30. Here, the decryption key issued by the license server 30 and included in the license may have been previously encrypted by the license server 30. The encrypted decryption key may be subsequently decrypted using a secret key stored in the security management unit 160.

The key extraction module 144 analyzes the license issued by the license server 30 in response to a request from the license management module 143, and extracts the decryption key. Here, if the decryption key included in the license has been previously encrypted by the license server 30, the decryption key extracted by the key extraction module 144 is an encrypted key.

The RO check module 145 checks whether the user terminal 10 has rights to play the encrypted DRM content. The RO check module 145 determines whether the user terminal 10 has rights to play the encrypted DRM content provided by the content server 20 based on the RO information included in the license issued by the license server 30 in response to a request from the license management module 143.

The decryption request module 146 requests the security management unit 160 to decrypt the encrypted DRM content provided by the content server 20. If, as a result of the determination of the RO check module 145 based on the RO information included in the license, it is determined that the user terminal 10 has rights to use the encrypted DRM content provided by the content server 20, the decryption request module 146 requests the security management unit 160 to decrypt the encrypted DRM content. In this case, the DRM content whose integrity has been verified by the content verification module 141, together with a decryption request from the decryption request module 146, is transferred from the DRM application management unit 120 to the security management unit 160.

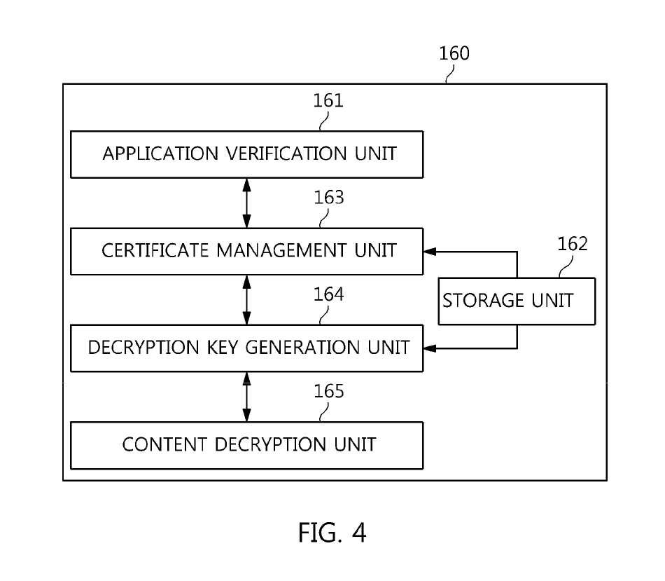

FIG. 4 is a diagram showing the configuration of the security management unit 160 of the user terminal 10 shown in FIG. 2, according to the present invention.

Referring to FIG. 4, the security management unit 160 includes an application verification unit 161, a storage unit 162, a certificate management unit 163, a decryption key generation unit 164, and a content decryption unit 165.

The application verification unit 161 verifies the integrity of the DRM application 140. The application verification unit 161 determines reliability including the integrity of the DRM application 140 that has been downloaded and stored in the DRM application management unit 120. If the reliability of the DRM application 140 is guaranteed, the application verification unit 161 requests the DRM application management unit 120 to execute the DRM application 140 in compliance with a user command.

The storage unit 162 stores a certificate that the license server 30 uses to authenticate the user terminal 10, and a secret key that is used to decrypt a decryption key encrypted and provided by the license server 30.

The certificate management unit 163 transfers the certificate for the user terminal 10, stored in the storage unit 162, to the DRM application 140 in response to a request from the DRM application 140.

The decryption key generation unit 164 generates a decryption key for decrypting DRM content by decrypting the encrypted decryption key, extracted and provided by DRM application 140, using the secret key stored in the storage unit 162.

The content decryption unit 165 decrypts the encrypted DRM content, provided by the content server 20, using the decryption key generated by the decryption key generation unit 164, and provides the decrypted DRM content to the content play platform 200. Here, if the RO check module 145 of the DRM application 140 determines that the user terminal 10 has rights to play the decrypted DRM content and there is a decryption request from the decryption request module 146 of the DRM application 140, the content decryption unit 165 decrypts the encrypted DRM content.

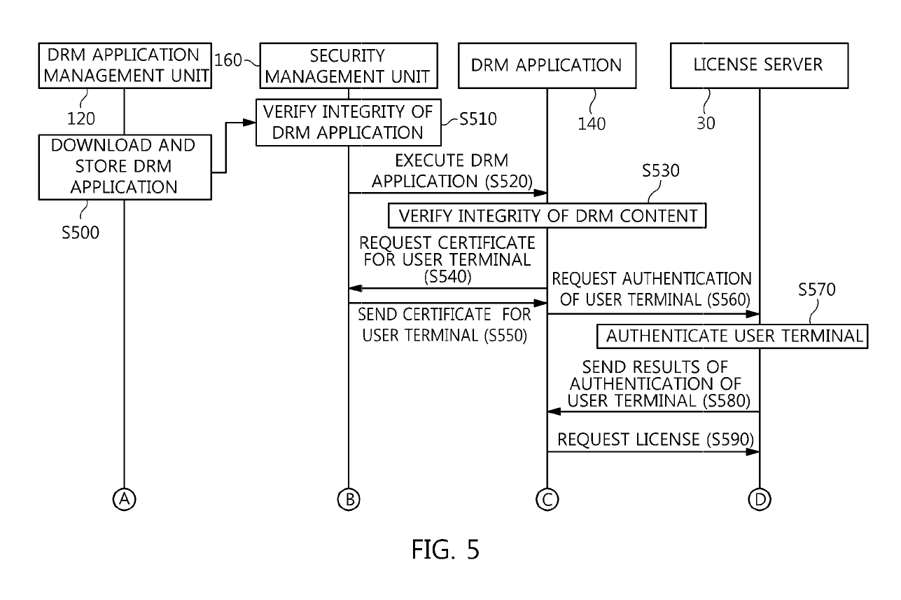

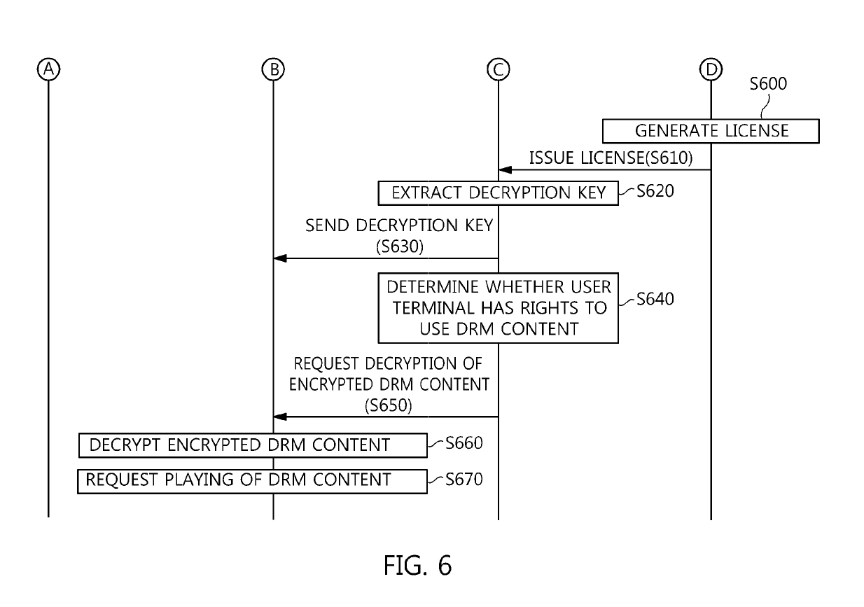

A method of playing DRM content according to the present invention will now be described with reference to FIG. 5 and FIG. 6. Descriptions that are identical to the descriptions of the operation of the user terminal for playing DRM content according to the present invention given with reference to FIGS. 1 to 4 will be omitted.

FIG. 5 and FIG. 6 are flowcharts illustrating the method of playing DRM content according to the present invention.

Referring to FIG. 5 and FIG. 6, in the method of playing DRM content according to the present invention, first, the DRM application management unit 120 of the common security platform 100 externally downloads the DRM application 140 suitable for DRM content, provided by the content server 20, in compliance with a user command and stores the downloaded DRM application 140 at step S500.

Thereafter, the security management unit 160 of the common security platform 100 verifies the integrity of the DRM application 140 stored in the DRM application management unit 120 at step S510.

Furthermore, if, as a result of the verification of the integrity of the DRM application 140 at step S510, it is determined that the reliability of the DRM application 140 is guaranteed, the security management unit 160 requests the DRM application management unit 120 to execute the DRM application 140 in compliance with a user command at step S520.

When the DRM application management unit 120 executes the DRM application 140 in compliance with the command at step S520, the DRM application 140 verifies the integrity of the encrypted DRM content provided by the content server 20 at step S530.

After performing the integrity of the encrypted DRM content at step S530, the DRM application 140 requests a certificate for the user terminal 10, used for the license server 30 to authenticate the user terminal 10, from the security management unit 160 at step S540. The security management unit 160 sends the certificate of the user terminal 10 to the DRM application 140 at step S550.

After the certificate of the user terminal 10 is transmitted at step S550, the DRM application 140 transfers the certificate of the user terminal 10 to the license server 30 and requests the license server 30 to authenticate the user terminal 10 at step S560. The license server 30 authenticates the user terminal 10 at step S570, and sends the results of the authentication of the user terminal 10 to the DRM application 140 at step S580.

After the authentication of the user terminal 10 has been completed at steps S560 to S580, the DRM application 140 requests a license for the encrypted DRM content provided by the content server 20 from the license server 30 at step S590. The license server 30 generates the license, including RO information about the encrypted DRM content and a decryption key capable of decrypting the encrypted DRM content, at step S600. The license server 30 issues the generated license to the DRM application 140 at step S610. At step S600, the license server 30 may encrypt the decryption key capable of decrypting the encrypted DRM content, and includes the encrypted decryption key in the license.

When the license is issued by the license server 30 at step S610, the DRM application 140 extracts the decryption key from the issued license at step S620, and sends the extracted decryption key to the security management unit 160 at step S630. Furthermore, the DRM application 140 extracts the RO information from the issued license and determines whether the user terminal 10 has rights to play the encrypted DRM content provided by the content server 20 based on the extracted RO information at step S640.

If, as a result of the determination at step S640, it is determined that the user terminal 10 has rights to play the encrypted DRM content, the DRM application 140 requests the security management unit 160 to decrypt the encrypted DRM content at step S650.

At step S660, in response to the decryption request from the DRM application 140 at step S650, the security management unit 160 decrypts the encrypted DRM content provided by the content server 20 using the decryption key received from the DRM application 140 at step S630. If the license server 30 has encrypted the decryption key capable of decrypting the encrypted DRM content and included the encrypted decryption key in the license at step S600, the security management unit 160 may generate the decryption key from the encrypted decryption key using a secret key stored in the storage unit 162.

Finally, after the process of decrypting the encrypted DRM content has completed at step S660, the security management unit 160 sends the decrypted DRM content to the content play platform 200 and also requests the content play platform 200 to play the decrypted DRM content at step S670. The content play platform 200 plays the DRM content decrypted by the security management unit 160.

As described above, the present invention has advantages in that it can guarantee safety because a core security function among the functions performed by the DRM agents of a conventional DRM system is implemented in the region of the common security platform of the user terminal and in that it can support various DRM methods in an extensible manner because the functions of the DRM agents other than the core security function are implemented in a downloadable application form.

Furthermore, the present invention is advantageous in that a plurality of pieces of content protected by various DRM techniques can be played on a single user terminal (N:1) and content protected by a specific DRM technique can be easily played even on various user terminals in different platform environments (1:N).

Furthermore, the present invention is advantageous in that the level of security identical to that of a conventional DRM agent can be maintained and a user terminal can play content protected by various DRM techniques.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A user terminal for playing Digital Rights Management (DRM) content, comprising a common security platform, the common security platform comprising
a DRM application management unit for storing and executing a DRM application configured to request authentication from a license server and to receive a license, including a decryption key for decrypting encrypted DRM content, wherein the DRM application is an application in a downloadable form; and
a security management unit for decrypting the encrypted DRM content, provided by a content providing server, using the decryption key included in the license issued via the DRM application.

2. The user terminal as set forth in claim 1, wherein:
the security management unit comprises a certificate management unit for providing a certificate for the user terminal, used to play the DRM content, to the DRM application; and
the DRM application comprises an authentication request module for requesting the license server to authenticate the user terminal by transferring the certificate for the user terminal to the license server.

3. The user terminal as set forth in claim 2, wherein the DRM application further comprises a license management module for requesting the license from the license server and receiving the license issued by the license server.

4. The user terminal as set forth in claim 3, wherein:
the decryption key is encrypted by the license server and included in the license; and
the DRM application further comprises a key extraction module for extracting the encrypted decryption key included in the license.

5. The user terminal as set forth in claim 4, wherein the security management unit further comprises a decryption key generation unit for generating the decryption key from the encrypted decryption key extracted by the key extraction module of the DRM application, using a secret key.

6. The user terminal as set forth in claim 5, wherein the security management unit further comprises a storage unit for storing the secret key and the certificate for the user terminal.

7. The user terminal as set forth in claim 1, wherein:
the license further comprises Rights Object (RO) information for the DRM content; and
the DRM application comprises an RO check module for checking whether the user terminal has rights to play the DRM content based on the RO information included in the license.

8. The user terminal as set forth in claim 7, wherein the DRM application further comprises a decryption request module for requesting the security management unit to decrypt the encrypted DRM content if the RO check module determines that the user terminal has rights to play the DRM content.

9. The user terminal as set forth in claim 8, wherein the security management unit comprises a content decryption unit for decrypting the encrypted DRM content in response to a request from the decryption request module of the DRM application.

10. The user terminal as set forth in claim 1, wherein the security management unit comprises an application verification unit for verifying integrity of the DRM application.

11. The user terminal as set forth in claim 1, wherein the DRM application comprises a content verification module for verifying integrity of the encrypted DRM content.

12. A method of playing DRM content, comprising:
by a DRM application management unit, downloading and storing a DRM application for requesting a license server to authenticate a user terminal for playing DRM content and for receiving a license, including a decryption key for decrypting encrypted DRM content;
by the DRM application management unit, executing the downloaded DRM application, requesting the authentication of the user terminal from the license server, and receiving results of the authentication;
by the DRM application management unit, requesting the license from the license server via the DRM application, and receiving the license from the license server;
by the DRM application management unit, extracting the decryption key from the license using the DRM application;
by a security management unit, decrypting the encrypted DRM content using the decryption key; and
by a content play platform, playing DRM content decrypted by the security management unit.

13. The method as set forth in claim 12, wherein the decrypting the encrypted DRM content using the decryption key comprises generating the decryption key from an encrypted decryption key using a secret key if the decryption key was encrypted by the license server.

14. The method as set forth in claim 12, further comprising, by the DRM application management unit, determining whether the user terminal has rights to play the DRM content based on Rights Object (RO) information included in the license by using the DRM application.

15. The method as set forth in claim 12, further comprising, by the security management unit, verifying integrity of the DRM application stored in the DRM application management unit.

16. The method as set forth in claim 12, further comprising, by the DRM application management unit, verifying integrity of the encrypted DRM content by using the DRM application.
